(19) United States
(12) Patent Application Publication
(10) Pub. No.: US 2007/0206466 A1
(43) Pub. Date: Sep. 6, 2007

(54) OPTIMUM POWER CONTROL FOR OPTICAL STORAGE MEDIA

(75) Inventors: Tony Petrus Van Endert, Eindhoven (NL); James Joseph Anthony McCormack, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,006

(22) PCT Filed: Mar. 11, 2005
(86) PCT No.: PCT/IB05/50879

§ 371 Date: Sep. 18, 2006

(30) Foreign Application Priority Data
Mar. 23, 2004 (EP) 04101200.6

(51) Int. Cl. G11B 7/12

(52) U.S. Cl. 369/47.53

(57) ABSTRACT

An optimal power calibration process in which an OPC process is performed on the outer OPC area (12) of an optical disc (10) at a plurality of write speeds a, b and c, and an OPC process is also performed on the inner OPC area (14) at the write speed thereof. The optimal powers (and strategies) obtained by each OPC process for each speed is then used to create a function matching writing power level to speed. In order to create an accurate optimum laser power for all radii, two OPC power factors can be created: a media variation power factor a speed power factor In order to create the media variation power factor, Nx1 OPC information obtained from both the innermost and the outermost radii of the optical disc are used; whereas in order to create the speed power factor, the Nx1, Nx2, . . . , Nxm information obtained from the outermost radius of the disc is used. Using the above-mentioned two power factors, more accurate control of the required laser power for all radii can be achieved.

This invention relates generally to Optimum Power Control (OPC) for optical storage media, and more particularly, to a method and apparatus for writing to an optical disc, whereby Optical Power Control (or Optimal Power Calibration) is performed at an outer edge of the disc.

An optical disc, such as a compact disc (CD), is known as one type of information recording media. According to a standard recording format of the CD, a recording area of the CD comprises a lead-in area, a program area, and a lead-out area. These areas are arranged in that order in a direction from an inner periphery to an outer periphery of the CD. Index information referred to as the table of contents (TOC) is recorded in the lead-in area. The TOC includes management information as a sub-code which is used for managing information recorded in the program area. For example, if main information recorded in the program area is information relating to a music tune, the management information may comprise the playing time of the tune. Information relating to the track number of the corresponding music tune may also be recorded in the program area. A lead-out code which indicates the end of the information area is recorded in the lead-out area.

Before user data is recorded, a test write is performed on a small segment of the media. The test write writes at various power levels and write pulse shapes. By reading back the test written pattern, the optimum power level and pulse shape are set, for recording the user data. This process is referred to as “Optimum Power Control” or “Optimal Power Calibration (OPC).

In more detail, the procedure of OPC is to first read a value of a recommended recording power (P0) which is recorded on the optical disc. Next, a test recording is executed wherein data is recorded using several levels of recording power based on the recommended recording power (P0). These test recordings are performed in a Power Calibration Area (PCA) of the optical disc. Based on the reproduction of the test data thus recorded, an optimum recording power for the optical disc is determined. The power calibration area (PCA) is also commonly referred to as and optimum power control (OPC) area. In the case of a constant linear velocity (CLV) disc, the linear velocity at which recording and reading operations are performed is constant, regardless of which track on the disc is being recorded or read. Because the disc is maintained at a constant linear velocity, recording characteristics are constant throughout the entire disc. Thus, a PCA is maintained in one area positioned in an inner area of the data recording area of a CLV disc.

Another rotational format, known as zoned constant linear velocity (ZCLV) is also popular. A ZCLV formatted disc is divided into a plurality of zones and is rotated at a constant linear velocity (CLV) within each zone. The angular velocity of the ZCLV disc changes as the disc is recorded or read in different zones. It will be appreciated that, if an optical disc is rotated at a constant angular velocity, then the linear velocity (i.e. writing speed) thereof will increase from the inner area of the disc towards the outer area. Constant Angular Velocity (CAV) recording formats are also known.

The present invention relates to (re)writable information storage systems where the speed of writing is so high that for the small inner radius of the disc, the linear velocity (i.e. the writing speed) must be restricted in order to keep the spindle rotation speed within acceptable bounds. In such systems, it is not possible to do an OPC at the inside of the disc at full speed, such that it is not possible to ascertain therefrom the correct laser power (and strategy settings).

A number of systems have been proposed in which OPC is performed on the outer area of the disc. However, media such as high-speed dvd+r media, exhibit large writing (and reading) related media variations at the outer area of the disc. Therefore, if only a single OPC is performed, whether that be at low speed at the inner area of the disc or at higher speed at the outer area, so as to create a function for predicting the correct laser power (and strategy settings) for all radii between the inner and outer areas of the disc, that prediction will not be particularly accurate.

It is an object of the present invention to provide a method and apparatus for performing OPC on optical storage media in which the disc variation between the inner and outer areas, which can be significant, is eliminated from the function mapping write speed to power (and strategy).

In accordance with the present invention, there is provided a method of performing optimum power control in respect of an optical storage device prior to writing data thereto, the method comprising performing an optimum power control process by:

a. performing a test write on a relatively small segment of said optical storage device; and

b. reading back the test pattern written to said optical storage device during performance of said test write;

in respect of a plurality of linear velocities of rotation of said optical storage device, so as to obtain a function mapping write speed to power, steps a) and b) being performed on substantially the same relatively small segment of said optical storage device for each of said plurality of linear velocities of rotation.

Also in accordance with the present invention, there is provided an apparatus for performing optimum power control in respect of an optical storage device prior to writing data thereto, the apparatus comprising means for performing an optimum power control process by performing a test write on a relatively small segment of said optical storage device and reading back the test pattern written to said optical storage device during performance of said test write in respect of a plurality of linear velocities of rotation of said optical storage device, so as to obtain a function mapping write speed to power, the test write in respect of each of said plurality of linear velocities of rotatation being performed on substantially the same relatively small segment of said optical storage device.

The present invention extends to a method of writing data to an optical storage device, including the method of performing optimum power control as defined above, and to apparatus for writing data to an optical storage device including the apparatus for performing optimum power control as defined above.

In a preferred embodiment, the relatively small segment comprises the outermost radius of the optical storage device. Beneficially, a first power factor is generated using the results of an optimum power control process performed at both the innermost and the outermost radii of the optical storage device, preferably at the write speed associated with the innermost radius. More preferably, a second power factor is generated using the results of an optimum power control process performed at a plurality of different write speeds on said outermost radius of the optical storage device. The optical storage device may comprise a zoned constant linear velocity (ZCLV) disc or a constant angular velocity (CAV) disc.

These and other aspects of the present invention will be apparent from, and elucidated with reference to, the embodiment described herein.

An embodiment of the present invention will now be described by way of example only and with reference to the accompanying drawings, in which:

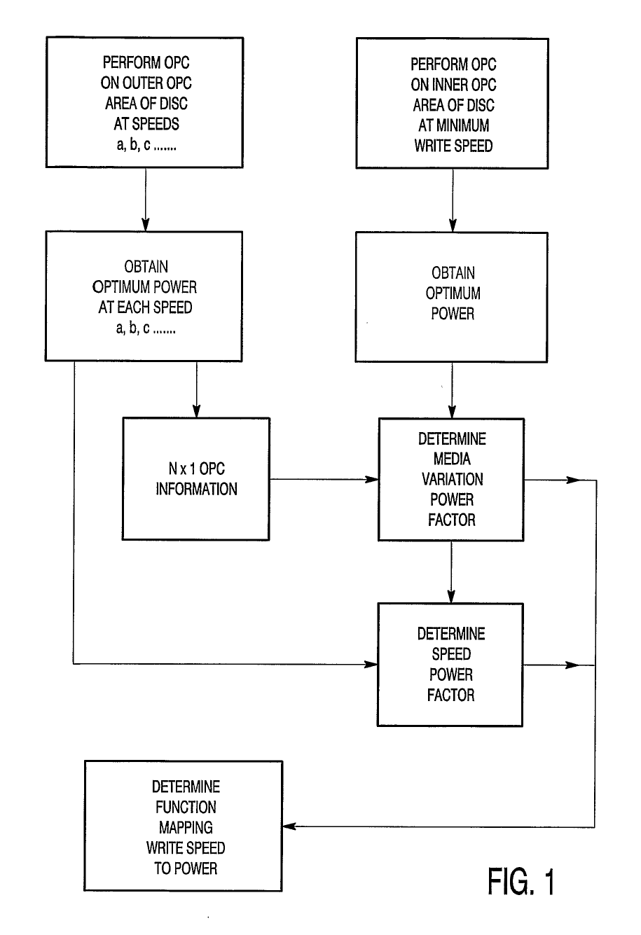

FIG. 1 is a schematic flow diagram illustrating the principal steps of a method according to an exemplary embodiment of the present invention;

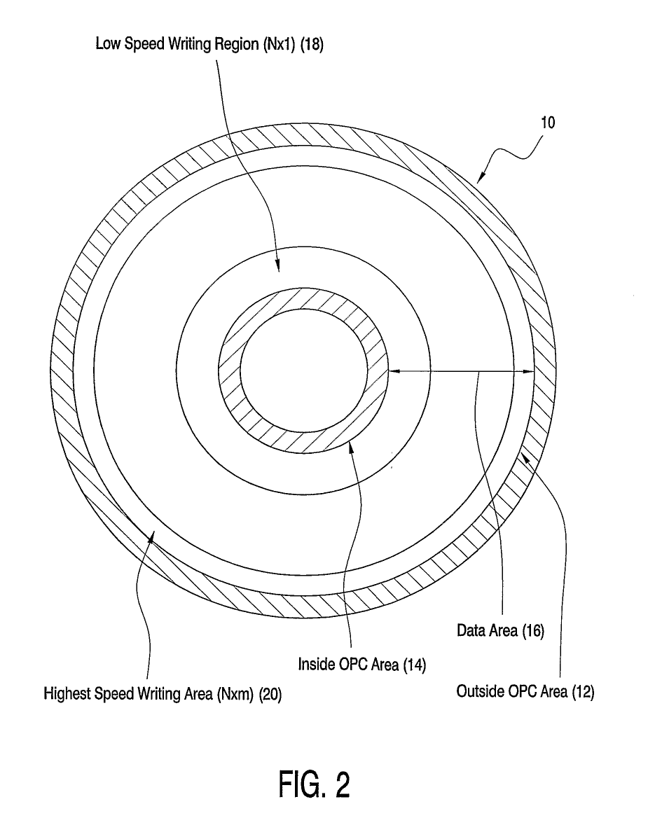

FIG. 2 is a schematic plan view of an optical storage disc, identifying various areas thereon;

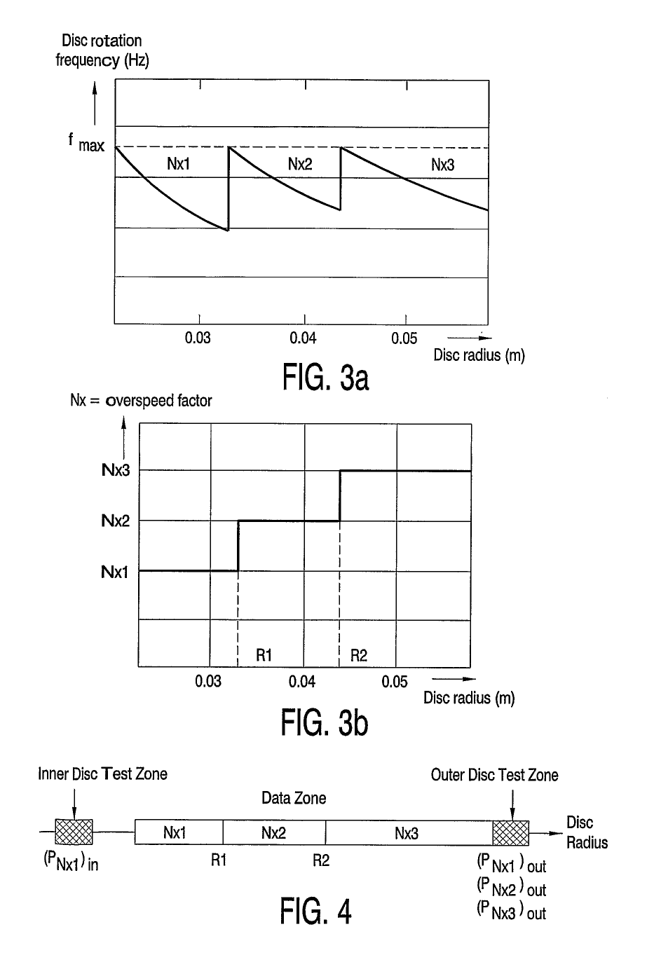

FIG. 3a is a graphical representation of the variation of disc rotation frequency with disc radius;

FIG. 3b is a graphical representation of the variation of overspeed factor Nx with disc radius; and

FIG. 4 is a schematic diagram illustrating the various zones of an optical storage disc during application of a method according to an exemplary embodiment of the present invention.

Thus, as explained above, it is an object of the present invention to provide a method and apparatus for performing OPC on optical storage media in which the disc variation between the inner and outer areas, which can be significant, is eliminated from the function mapping write speed to power (and strategy). The invention applies to (re)writable information storage systems where the speed of writing at the inner area of the disc is less than the speed of writing elsewhere on the disc. This is the case in optical storage systems (e.g. CD, DVD) where the speed of writing is so high that for the small inner radius, the linear velocity (i.e. the writing speed) must be restricted in order to keep the spindle motor rotation speed within acceptable bounds. In such systems it is not possible to do an OPC at the inside radius of the disc at full speed. In an attempt to overcome this problem, a number of systems have been proposed in which OPC is performed at the outer radius of the disc.

European Patent Application No. 0905685 describes a method of performing OPC in respect of an optical storage device, in order to take into account any temperature changes which may occur during recording of information, and also to prevent a decrease in processing speed. In the described method, whenever a change in temperature of the optical storage device is detected, a new test recording is performed, which test recording may be performed in respect of three areas: the innermost peripheral area, an outermost peripheral area and an intermediate area of the recordable area.

U.S. Pat. No. 6,052,347 describes a method of determining optimum recording power for a zoned constant linear velocity (ZCLV) formatted optical disc by making multiple test recordings in an area of the ZCLV formatted optical disc corresponding to the recording characteristics of the entire disc and determing optimum recording power based on the test recordings. In the described method, two (different) OPC areas are written with varying recording powers in each constant angular velocity (CAV) zone of the disc.

The present invention is prompted by the fact that high speed optical media, such as dvd+r (e.g. 8× on 4× media or 8× on 8× media) exhibit significant writing (and reading) related media variations on the outside (e.g. beta). This means that just using a low-speed OPC on the innermost radius and a high speed OPC on the outermost radius, as in the prior art, to create a function for relating write speed to power (write strategy) does not work reliably across the disc, because of this variation. The present invention, on the other hand proposes to perform a plurality of test recordings on substantially the same place on an optical disc at a plurality of respective write speeds between a minimum (preferably the linear velocity at the innermost radius of the optical disc) and a maximum speed (preferably the linear velocity at the outermost radius of the optical disc).

A major improvement afforded by the present invention is that the disc variation between inside and outside can be eliminated from the function mapping write speed to power (and strategy) because the test recordings at different linear velocities are performed at the same local location on the disc. The most logical place on the disc to perform the OPC in this case is the outermost radius because it covers all possible write speeds and does not disturb the continuous active data area common in most systems. In MRW systems (Mount Rainier), a variant is possible in which such OPC's could be performed in the replacement area zones from outside to inside as well.

Referring to FIG. 2 of the drawings, an optical storage disc 10 has an outermost radius 12 defining an outer OPC area, an innermost radius 14 defining an inner OPC area, and a data area 16 between the two OPC areas 12, 14. The data area 16 is made up of a plurality of writing regions for storing user data, including a tow speed writing region 18 (having an overspeed factor Nx1 which is the same as that of the inner OPC area 14) which is immediately adjacent the inner OPC area 14, and a maximum speed writing region 20 (having an overspeed factor Nxm) which is immediately adjacent the outer OPC area 12. Within the inner OPC area 14, OPC can only be performed at a write speed of Nx1, whereas within the outer OPC area 12, OPC can be performed at all write speeds Nx1, Nx2, . . . , Nxm.

Referring to FIG. 1 of the drawings, in a method according to an exemplary embodiment of the present invention, first an OPC process is performed on the outer OPC area 12 at a plurality of write speeds a, b and c, and an OPC process is also performed on the inner OPC area 14 at the write speed thereof. An OPC for any given write speed is a procedure known to a person skilled in the art, in which firstly a number of power levels and/or strategy timings/forms are used to write test data. At this time, writing quality related parameters may be recorded. The test data is then read back and judged on readability or written quality (eg BLER, jitter, beta, gamma). It is common in this procedure to use fitting and filtering techniques to obtain the optimal power for a given speed.

In this exemplary embodiment of the present invention, a significant advance relative to the prior art is that the optimal powers (and strategies) obtained for each speed is then used to create a function matching writing power level to speed. A preferred fitting function is a linear regression given the range of speeds possible (high<=2.5×low), media and the number of test speeds possible.

Referring additionally to FIGS. 3a, 3b and 4 of the drawings, the relationship between overspeed factor Nx and disc radius R is:

$${N}_{x} = \frac{2 \cdot π \cdot R \cdot {f}_{disc}}{{v}_{1 x}}$$

where

Nx=overspeed factor

R=disc radius

F_{disc}=disc rotation frequency

V₁ₓ=linear velocity

Overspeed factor Nx increases as function of the disc radius

Consider the case in which it is required to write a disc with a certain overspeed factor Nx2 with a given maximum rotation frequency (e.g. 80 Hz). A simple solution is to write at a lower speed (Nx1) for the OPC area 14 of the disc 10 until the radius is reached which allows Nx2 to be used (for the remaining outside area of the disc).

In order to create an accurate optimum power, two OPC power factors are created: one for media variations and one for speed. To create the media variation power factor, Nx OPC information is used from the inside and the outside disc radius. In order to create the speed power factor, use Nx1 and Nx2 information from the outside radius.

For example, a ZCLV profile (sequential writing from inside to outside disc) with three different speeds/zones (Nx1, Nx2 and Nx3) with a max disc rotation frequency of fₘₐₓ (for power consumption reduction applications, e.g. notebooks).

Optimal write power from OPC at inside disc: (P_{Nx1})ᵢₙ

Write power calculation for zone 2 at transition R1:

$${( {P}_{Nx 2} )}_{R 1} = {( {P}_{Nx 1} )}_{i n} \cdot {K}_{Nx 2 / Nx 1} \pm Δ {P}_{WOPC ( zone 1 )}$$

$$where$$

$${K}_{Nx 2 / Nx 1} = \frac{( {}^{P} Nx 3 ) out}{( {}^{P} Nx 1 ) out}$$

$$Δ {P}_{WOPC ( zone 1 )} = {( {P}_{Nx 1} )}_{R 1} - {( {P}_{Nx 1} )}_{i n}$$

Write power calculation for zone 3 at transition R2:

$${( {P}_{Nx 3} )}_{R 2} = {( {P}_{Nx 1} )}_{i n} \cdot {K}_{Nx 3 / Nx 1} \pm Δ {P}_{WOPC ( zone 1 \& 2 )}$$

$$where$$

$${K}_{Nx 3 / Nx 1} = \frac{( {}^{P} Nx 3 ) out}{( {}^{P} Nx 1 ) out}$$

$$\begin{matrix}Δ {P}_{WOPC ( Zone 1 \& 2} = Δ {P}_{WOPC ( zone 1 )} + {( {P}_{Nx 2} )}_{R 2} - {( {P}_{Nx 2} )}_{R 1} \\ = Δ {P}_{WOPC ( zone 1 )} + Δ {P}_{WOPC ( zone 2 )}\end{matrix}$$

In a preferred embodiment of the invention, in order to create an accurate optimum laser power for all radii, two OPC power factors can be created:

a media variation power factor

a speed power factor

In order to create the media variation power factor, Nx1 OPC information obtained from both the innermost and the outermost radii of the optical disc are used; whereas in order to create the speed power factor, the Nx1, Nx2, . . . , Nxm information obtained from the outermost radius of the disc is used. Using the above-mentioned two power factors, more accurate control of the required laser power for all radii can be achieved. This improved OPC method increases the reliability of the writing/reading processes, and is applicable at least to (re)writable information storage systems where the write speed at the innermost radius of the disc is less than that elsewhere, and in particular to optical storage systems.

An embodiment of the present invention has been described above by way of example only, and it will be apparent to a person skilled in the art that modifications and variations can be made to the described embodiment without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. A method of performing optimum power control in respect of an optical storage device (10) prior to writing data thereto, the method comprising performing an optimum power control process by:
a. performing a test write on a relatively small segment (12) of said optical storage device (10); and
b. reading back the test pattern written to said optical storage device (10) during performance of said test write;
in respect of a plurality of linear velocities of rotation of said optical storage device (10), so as to obtain a function mapping write speed to power, steps (a) and (b) being performed on substantially the same relatively small segment (12) of said optical storage device (10) for each of said plurality of linear velocities of rotation.

2. A method according to claim 1, wherein the relatively small segment comprises the outermost radius (12) of the optical storage device (10).

3. A method according to claim 1, wherein an optimum power control process performed at both the innermost (14) and the outermost radii (12) of the optical storage device (10).

4. A method according to claim 3, wherein said optimum power control process is performed at the write speed associated with the innermost radius.

5. A method according to claim 1, wherein power factor is generated using the results of an optimum power control process performed at a plurality of different write speeds on said outermost radius (12) of the optical storage device (10).

6. A method according to claim 1, wherein the optical storage device (10) comprises a zoned constant linear velocity (ZCLV) disc or a constant angular velocity (CAV) disc.

7. Apparatus for performing optimum power control in respect of an optical storage device prior to writing data thereto, the apparatus comprising means for performing an optimum power control process by performing a test write on a relatively small segment of said optical storage device and reading back the test pattern written to said optical storage device during performance of said test write in respect of a plurality of liner velocities of rotation of said optical storage device, so as to obtain a function mapping write speed to power, the test write in respect of each of said plurality of linear velocities or rotation being performed on substantially the same relatively small segment of said optical storage device.

8. A method of writing data to an optical storage device (10) including the method according to claim 1.

9. Apparatus for writing data to an optical storage device (10) including the apparatus for performing optimum power control according to claim 7.
